(19) United States
(12) Patent Application Publication
(10) Pub. No.: US 2008/0003343 A1
(43) Pub. Date: Jan. 3, 2008

(54) Dissolving element

(76) Inventor: Patriek Destrooper, Lo (Reninge) (BE)

Correspondence Address: BACON & THOMAS, PLLC, 625 SLATERS LANE, FOURTH FLOOR, ALEXANDRIA, VA, 22314, US

(21) Appl. No.: 11/492,881

(22) Filed: Jul. 26, 2006

(30) Foreign Application Priority Data
Jun. 29, 2006 (BE) 2006/0359

(51) Int. Cl. A23F 5/00

(52) U.S. Cl. 426/594

(57) ABSTRACT

A dissolving element which can be dissolved in a liquid (6) so as to make a drink, wherein this dissolving element (1) consists of a chocolate or imitation chocolate coating (2) in which has been provided a measured amount of soluble powder (4).

### BACKGROUND OF THE INVENTION

1. Field of the invention

The present invention concerns a dissolving element.

In particular, the invention concerns a dissolving element which can be solved in a liquid so as to make a drink.

2. Discussion of the Related Art

A dissolving element in the shape of a solid piece of chocolate provided on a stick is already known.

In use, the above-mentioned stick with the piece of chocolate is immersed for example in hot milk, and a user stirs this stick in the milk until the chocolate has melted and has been mixed with the milk so as to form chocolate milk.

A disadvantage of such known dissolving elements is that it takes very long for the chocolate to melt, meaning that a user has to keep stirring for a long while.

Another disadvantage of such a known dissolving element is that the stick can no longer be used afterwards and is thrown away, which is detrimental to the environment as waste is produced in this manner.

An additional disadvantage of such a known dissolving element is that, due to the presence of the stick, it occupies relatively much space during the storage and transport.

### SUMMARY OF THE INVENTION

The present invention aims to remedy one or several of the above-mentioned and other disadvantages.

To this end, the present invention concerns a dissolving element which can be solved in a liquid so as to make a drink, whereby this dissolving element consists of a chocolate or imitation chocolate wrapping in which has been provided a measured amount of soluble powder.

An advantage of such a dissolving element according to the invention is that it is solved considerably faster in a hot liquid than the conventional dissolving elements made of solid chocolate.

According to a preferred embodiment, the dissolving element is used without a stick.

An advantage of such a dissolving element is that less waste is produced than with the known dissolving elements which do have a stick.

An additional advantage thereof is that the dissolving elements can be packed, stored and conveyed in a very compact manner, which saves costs.

According to a preferred embodiment of a dissolving element according to the invention, said chocolate wrapping is shaped as a little tub which is sealed at the top with a chocolate top layer.

This is advantageous in that the measured amount of soluble powder is entirely packed so to say in the chocolate wrapping and thus cannot get lost during transport or cannot be spilled during use.

Moreover, such a dissolving element can be produced in a rather simple and cheap manner.

### BRIEF DESCRIPTION OF THE DRAWINGS

In order to better explain the characteristics of the invention, the following preferred example of a few preferred embodiments of a dissolving element according to the invention are described as an example only without being limitative in any way, with reference to the accompanying drawings, in which:

FIG. 1 schematically represents a dissolving element according to the invention, seen in perspective;

FIG. 2 represents a section according to line II-II in FIG. 1;

FIG. 3 illustrates the use of a dissolving element according to FIG. 1;

FIG. 4 represents a dissolving element according to FIG. 1 when packed.

### DESCRIPTION OF THE PREFERED EMBODIMENTS

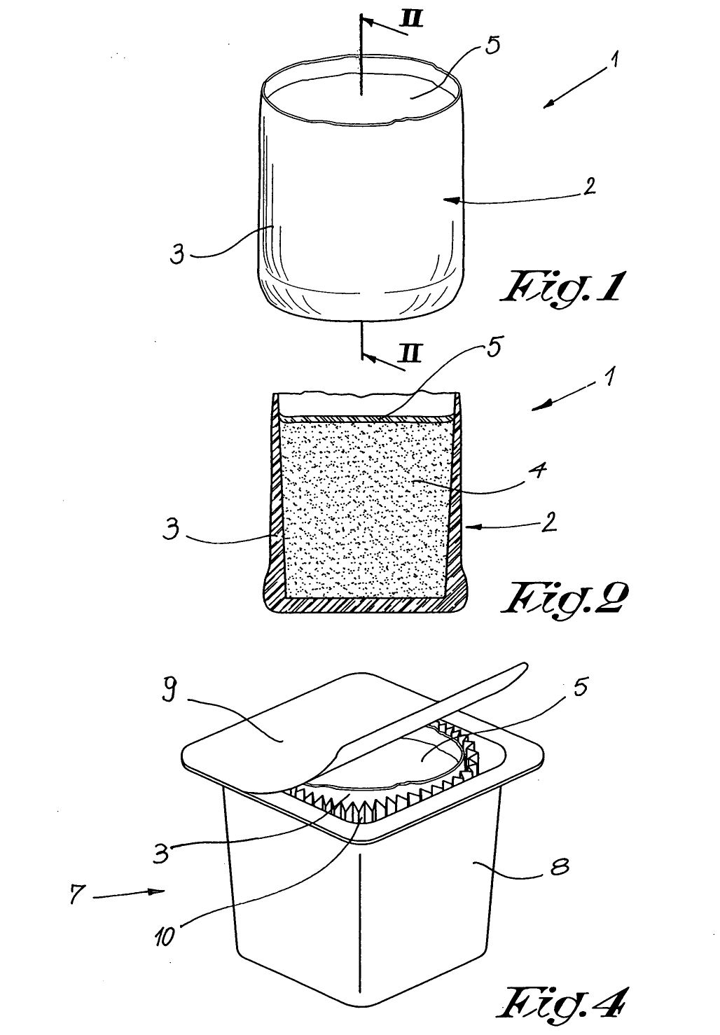

FIGS. 1 and 2 represent a dissolving element 1 according to the invention which mainly consists of a chocolate wrapping 2 in the shape of a little tub 3 in which has been provided a measured amount of soluble powder 4 and which, in this case but not necessarily, is sealed at the top with a chocolate top layer 5.

The chocolate wrapping 2 can be made of any sort of chocolate whatsoever, such as milk chocolate, white chocolate, dark chocolate and/or mixtures of different types of chocolate.

It is clear that said coating may also be made of imitation chocolate.

The above-mentioned soluble powder 4 may consist for example of cocoa powder, but the invention is not restricted as such and comprises any soluble powder or mixture of soluble powders which allows to make a drink by dissolving it in a hot liquid.

According to alternative embodiments of a dissolving element 1 according to the invention, said soluble powder 4 may comprise one or several of the following ingredients: milk powder, coffee powder, tea powder, powdered sugar and the like.

Moreover, all sorts of additives may be added to the powder 4 or to the chocolate such as flavors, aromatics, preservatives, vitamins, coloring agents and/or the like.

The soluble powder 4 may be either or not condensed according to the invention.

Also, certain additives or garnishings may be provided, for example such as crushed nuts, whipped cream or the like.

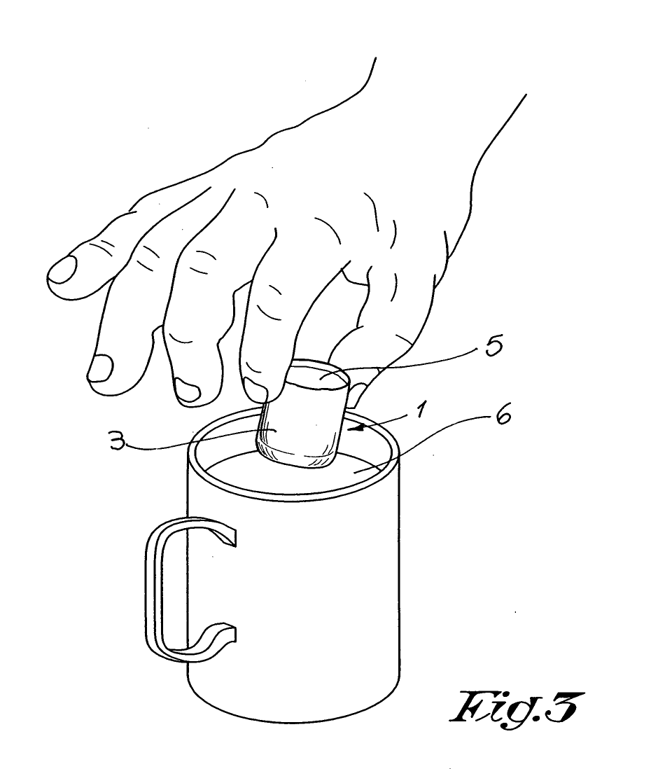

The use of a dissolving element according to the invention is very simple and is represented in FIG. 3.

A user hereby puts the dissolving element 1 in a cup of hot liquid 6 such as water, milk or the like, after which the chocolate wrapping 2, as well as the measured amount of soluble powder 4 provided therein, dissolves quickly.

Of course, the measured amount of powder and chocolate is selected such that a nice drink is obtained by dissolving a single dissolving element 1 in a normal-sized cup.

A practical application of the invention makes use of a dissolving element 1 which consists of a chocolate wrapping 2 in which has been provided a measured amount of cocoa powder to make a nice cup of chocolate milk by dissolving said dissolving element 1 in a cup of hot milk.

A dissolving element 1 according to the invention is preferably provided in a packing 7 during its transport and storage, for example as represented in FIG. 4.

The packing 7 in this case consists of a plastic holder 8, which holder 8 is hermetically sealed at the top by means of a cover foil 9, a lid or the like.

In this case, but not necessarily, the dissolving element 1 is provided on a paper wrapping 10, which makes it possible to take the dissolving element out of the holder 8 so as to put it in a cup of hot liquid without getting one's fingers dirty.

Such a closed packing 7 is advantageous in that the dissolving element 1 can be stored, conveyed and offered to the end user in a hygienic manner.

Moreover, such a packing 7 provides a very long shelf life to the dissolving element 1 and makes sure that its aroma is preserved for a long time.

Moreover, such packing is compact, which saves space during the storage and transport.

According to a special characteristic of the invention, one or several aromatic substances which are not represented in the figures may be provided in the above-mentioned packing 7.

Although the figures represent a coating in the shape of a little tub, it goes without saying that it can also be realized in many other shapes, for example in the shape of a logo, a little heart or any other figure whatsoever, or that it may be provided with a superscription, an advertising text or the like which has been cast in together with the chocolate.

The present invention is by no means restricted to the embodiments given as an example and represented in the accompanying drawings; on the contrary, such a dissolving element 1 according to the invention can be made in all sorts of shapes and dimensions while still remaining within the scope of the invention.

1. A dissolving element which can be dissolved in a liquid so as to make a drink, said dissolving element comprising a chocolate or imitation chocolate wrapping in which has been provided a measured amount of soluble powder.

2. The dissolving element according to claim 1, wherein said wrapping comprises a little tub.

3. The dissolving element according to claim 2, wherein said little tub is sealed at the top with a chocolate top layer.

4. The dissolving element according to claim 1, wherein said soluble powder comprises one or several of the following powders: cocoa powder, mild powder, coffee powder, tea powder, powdered sugar and other powders.

5. The dissolving element according to claim 1, wherein said dissolving element is packed in a hermetically sealed packing.

6. The dissolving element according to claim 5, wherein said dissolving element is placed on a paper wrapping which is provided in said packing.

7. The dissolving element according to claim 5, wherein at least one aromatic substance is provided in said packing.

8. The dissolving element according to claim 1, wherein at least one additive is added to the powder or to the chocolate such as flavors, aromatics, preservatives, vitamins, coloring agents and/or the like.

9. The dissolving element according to claim 1, wherein said dissolving element is not provided with a stick.

10. The dissolving element according to claim 1, wherein said powder is provided in a measured amount which is suitable to make one cup of a drink.

11. the dissolving element according to claim 1, wherein said powder is condensed.
